(19) United States
(12) Patent Application Publication
(10) Pub. No.: US 2025/0349280 A1
(43) Pub. Date: Nov. 13, 2025

(54) NOISE REDUCTION EARPHONE AND CALIBRATION METHOD FOR NOISE REDUCTION

(71) Applicant: Lanto Electronic Limited, Kunshan City (CN)

(72) Inventors: Che-Yung HUANG, Taipei City (TW); Kun-Ting TSAI, Taipei City (TW); Yong-Sheng JHENG, Taipei City (TW); Che-Yi HSIAO, Taipei City (TW); Chi-Liang CHEN, Taipei City (TW)

(73) Assignee: Lanto Electronic Limited, Kunshan City (CN)

(21) Appl. No.: 18/923,428

(22) Filed: Oct. 22, 2024

(30) Foreign Application Priority Data
May 9, 2024 (CN) 202410571552.1

(51) Int. Cl. G10K 11/178; H04R 1/10

(52) U.S. Cl. CPC G10K 11/17825; G10K 11/17875; H04R 1/1041; H04R 1/1083; G10K 2210/1081; G10K 2210/3011; G10K 2210/3026; G10K 2210/3056; G10K 2210/504; H04R 2460/01

(57) ABSTRACT

Disclosed is a noise reduction earphone including a memory, a speaker, a feedback microphone and a processor. The memory stores a target frequency response curve and a target frequency response difference corresponding to a sound signal. The feedback microphone collects a feedback signal corresponding to the sound signal. The processor receives a start signal and then performs a calibration process including (a) controlling the speaker to play the sound signal; (b) receiving the feedback signal; (c) generating a feedback frequency response curve based on the feedback signal, and obtaining a feedback frequency response difference between the target frequency response curve and the feedback frequency response curve; (d) adjusting a low-frequency gain of the feedback microphone when the feedback frequency response difference is less than or greater than the target frequency response difference, and returning to (a) until the feedback frequency response difference is equal to the target frequency response difference.

### CROSS REFERENCE TO RELATED PRESENT DISCLOSURE

This application claims the priority benefit of Chinese Patent Application Serial Number 202410571552.1, filed on May 9, 2024, the full disclosure of which is incorporated herein by reference.

### TECHNICAL FIELD

The present disclosure relates to the technical field of acoustics, in particular to a noise reduction earphone and a calibration method for noise reduction.

### RELATED ART

Earphones have been widely used in people's daily life and work. To improve the noise reduction effect of earphones, active noise reduction technology is generally used for noise reduction. The method adopted by active noise reduction technology is to emit an audio signal with a similar amplitude and opposite phase to the noise through the speaker in the earphone, thereby reducing the noise heard by a user.

However, when different users wear earphones, due to different feedback caused by ear canals of the different users, the feedback noise reduction performance of the noise reduction earphone cannot meet the usage requirements of different users, affecting the noise reduction experience.

Therefore, it is urgent to provide a noise reduction earphone and a calibration method for noise reduction, which can improve the feedback noise reduction performance of the earphone in different wearing environments to solve the above problems.

### SUMMARY

The embodiments of the present disclosure provide a noise reduction earphone and a calibration method for noise reduction, which can solve the problem that the feedback noise reduction performance of the existing noise reduction earphone cannot meet the usage requirements of different users due to different feedback caused by the ear canals of different users, thus affecting the noise reduction experience.

To solve the above technical problem, the present disclosure is implemented as follows:

The present disclosure provides a noise reduction earphone, which includes a memory, a speaker, a feedback microphone and a processor, and the processor is connected to the memory, the speaker and the feedback microphone. The memory is configured to store a target frequency response curve and a target frequency response difference corresponding to a sound signal. The feedback microphone is configured to collect a feedback signal corresponding to the sound signal. The processor is configured to perform a calibration process for feedback noise reduction after receiving a start signal, and the calibration process for feedback noise reduction includes the following steps: (a) controlling the speaker to play the sound signal; (b) receiving the feedback signal; (c) generating a feedback frequency response curve based on the feedback signal, and obtaining a feedback frequency response difference between the target frequency response curve and the feedback frequency response curve; (d) adjusting a low-frequency gain of the feedback microphone when it is determined that the feedback frequency response difference is less than or greater than the target frequency response difference, and returning to step (a) until it is determined that the feedback frequency response difference is equal to the target frequency response difference.

The present disclosure provides a calibration method for noise reduction, which is applied to a noise reduction earphone including a memory, a speaker and a feedback microphone. The calibration method for noise reduction includes the following steps: (A) receiving a start signal; (B) controlling a speaker to play a sound signal; (C) receiving a feedback signal corresponding to the sound signal collected by a feedback microphone; (D) generating a feedback frequency response curve based on the feedback signal, and obtaining a feedback frequency response difference between a target frequency response curve corresponding to the sound signal stored in the memory and the feedback frequency response curve; and (E) adjusting a low-frequency gain of the feedback microphone when it is determined that the feedback frequency response difference is less than or greater than the target frequency response difference stored in the memory, and returning to step (B) until it is determined that the feedback frequency response difference is equal to the target frequency response difference.

In the noise reduction earphone and the calibration method for noise reduction of the embodiments of the present disclosure, when the feedback frequency response difference between the target frequency response curve and the feedback frequency response curve corresponding to the same sound signal is less than or greater than the target frequency response difference, the low-frequency gain of the feedback microphone is adjusted until it is determined that the feedback frequency response difference is equal to the target frequency response difference, so as to improve the feedback noise reduction performance of the noise reduction earphone in different wearing environments, wherein the different feedback of different users after wearing the noise reduction earphone can be reflected in the different feedback frequency response curves corresponding to the sound signal.

### BRIEF DESCRIPTION OF THE DRAWINGS

Accompanying drawings described herein are intended to provide a further understanding of the present disclosure and form a part of the present disclosure, and exemplary embodiments of the present disclosure and descriptions thereof are intended to explain the present disclosure but are not intended to unduly limit the present disclosure. In the drawings:

FIG. 1 is a block diagram of a noise reduction earphone according to an embodiment of the present disclosure;

FIG. 2 is a schematic diagram of frequency response curves generated when the feedback noise reduction function is turned on and off after the noise reduction earphone of the present disclosure performs the noise reduction detection and adaptation process before leaving the factory;

FIG. 3 is a block diagram of a noise reduction earphone according to another embodiment of the present disclosure;

FIG. 4 is a block diagram of a noise reduction earphone according to still another embodiment of the present disclosure; and

FIG. 5 is a flow chart of a calibration method for noise reduction according to an embodiment of the present disclosure.

### DETAILED DESCRIPTION OF THE EMBODIMENTS

The embodiments of the present disclosure will be described below in conjunction with the relevant drawings. In the figures, the same reference numbers refer to the same or similar components or method flows.

It must be understood that the words “including”, “comprising” and the like used in this specification are used to indicate the existence of specific technical features, values, method steps, work processes, elements and/or components. However, it does not exclude that more technical features, values, method steps, work processes, elements, components, or any combination of the above can be added.

It must be understood that when an element is described as being “connected” or “coupled” to another element, it may be directly connected or coupled to another element, and intermediate elements therebetween may be present. In contrast, when an element is described as “directly connected” or “directly coupled” to another element, there is no intervening element therebetween.

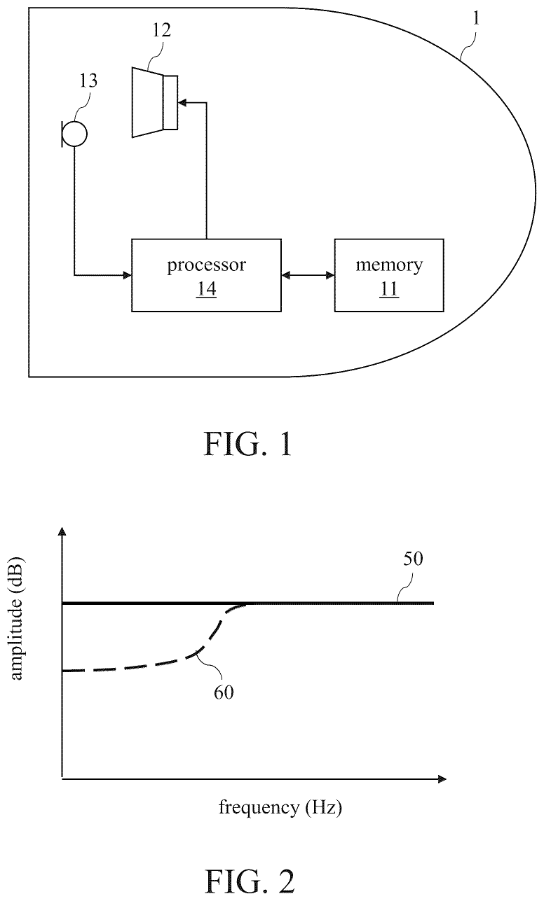

Please refer to FIG. 1, which is a block diagram of a noise reduction earphone according to an embodiment of the present disclosure. As shown in FIG. 1, a noise reduction earphone 1 comprises a memory 11, a speaker 12, a feedback microphone 13 and a processor 14, the processor 14 is connected to the memory 11, the speaker 12 and the feedback microphone 13, and the feedback microphone 13 is located on the sound-emitting side of the speaker 12. The noise reduction earphone 1 may be, but is not limited to, a headphone, an in-ear earphone or an earmuff earphone. The processor 14 may comprise, but is not limited to, a digital signal processor (DSP), a central processing unit (CPU), a system on chip (SoC) or a microcontroller unit (MCU), and may further comprise an analog-to-digital converter and a digital-to-analog converter to facilitate data transmission between the processor 14 and the speaker 12 and between the processor 14 and the feedback microphone 13.

The memory 11 is configured to store a target frequency response curve and a target frequency response difference corresponding to a sound signal. Specifically, the noise reduction earphone 1 undergoes a noise reduction detection and adaptation process before leaving the factory, wherein during the noise reduction detection and adaptation process, the frequency response curve generated by the noise reduction earphone 1 based on the feedback signal collected by the feedback microphone 13 corresponding to the sound signal is adjusted to the target frequency response curve, and the target frequency response difference of the noise reduction earphone 1 is obtained at the same time. The memory 11 is configured to store the target frequency response curve corresponding to the sound signal and the target frequency response difference, so as to facilitate the execution of the calibration process for feedback noise reduction after the noise reduction earphone 1 leaves the factory.

For example, please refer to FIG. 2, which is a schematic diagram of frequency response curves generated when the feedback noise reduction function is turned on and off after the noise reduction earphone of the present disclosure performs the noise reduction detection and adaptation process before leaving the factory, wherein the horizontal axis represents frequency in Hertz (Hz), the vertical axis represents amplitude in dB, and curve 50 partially overlaps with curve 60. When the feedback noise reduction function of the noise reduction earphone 1 is not turned on, although the speaker 12 plays the sound signal, the feedback microphone 13 does not start to operate, so that the frequency response curve generated by the noise reduction earphone 1 based on the feedback signal corresponding to the sound signal may be but not limited to the curve 50 shown in FIG. 2. After the feedback noise reduction function of the noise reduction earphone 1 is turned on, the speaker 12 plays the sound signal, the feedback microphone 13 starts to operate, and the processor 14 treats the feedback signal corresponding to the sound signal collected by the feedback microphone 13 as a noise signal and performs noise reduction processing, causing the amplitude of the frequency response curve generated by the noise reduction earphone 1 based on the feedback signal corresponding to the sound signal to attenuate in the low frequency band, as shown by curve 60 in FIG. 2. Therefore, the target frequency response difference may be the average attenuation value in the low frequency band of the frequency response curve generated by the noise reduction earphone 1 based on the feedback signal corresponding to the sound signal, and the target frequency response curve may be the curve 60, but this example is not used to limit the present disclosure. Among them, the low frequency band can be but not limited to 20 Hz to 2000 Hz.

In one example, the target frequency response difference may be, but is not limited to, 0 dB (that is, during the noise reduction detection and adaptation process of the noise reduction earphone 1, the amplitude attenuation in the low frequency band of the frequency response curve generated by the feedback signal corresponding to the sound signal has been compensated and adjusted).

It should be noted that, since the above-mentioned noise reduction detection and adaptation process is to adjust the feedback noise reduction function of the noise reduction earphone 1, the sound signal needs to comprise a low frequency signal, wherein the frequency of the low frequency signal may be, but is not limited to, 20 Hz to 2000 Hz.

The feedback microphone 13 is configured to collect the feedback signal corresponding to the sound signal. The processor 14 is configured to perform a calibration process for feedback noise reduction after receiving a start signal, and the calibration process for feedback noise reduction comprises the following steps: (a) controlling the speaker 12 to play the sound signal; (b) receiving the feedback signal; (c) generating a feedback frequency response curve based on the feedback signal, and obtaining a feedback frequency response difference between the target frequency response curve and the feedback frequency response curve; (d) adjusting a low-frequency gain of the feedback microphone when it is determined that the feedback frequency response difference is less than or greater than the target frequency response difference, and returning to the step (a) until it is determined that the feedback frequency response difference is equal to the target frequency response difference. The above step (a) to step (c) can be defined as feedback noise reduction detection.

Specifically, after receiving the start signal, the processor 14 controls the speaker 12 to play the sound signal. At this time, the feedback microphone 13 collects a feedback signal corresponding to the sound signal, and the feedback signal can reflect the differences in the ear canals of different users. Then, the processor 14 receives the feedback signal, generates a corresponding feedback frequency response curve based on the feedback signal, and subtracts the target frequency response curve from the feedback frequency response curve to calculate the feedback frequency response difference, wherein the feedback frequency response difference may be, but is not limited to, the maximum amplitude difference. Next, when the processor 14 determines that the feedback frequency response difference is less than or greater than the target frequency response difference, the processor 14 adjusts the low-frequency gain of the feedback microphone 13, controls the speaker 12 to play the sound signal again, generates a new feedback frequency response curve, obtains a new feedback frequency response difference, and determines whether the feedback frequency response difference is equal to the target frequency response difference. If so, it means that the calibration process for feedback noise reduction is completed. If not, the low-frequency gain of the feedback microphone 13 is adjusted and the feedback noise reduction detection is performed again.

In other words, the processor 14 is configured to monitor the feedback frequency response difference obtained when the noise reduction earphone 1 plays the sound signal with the feedback noise reduction function turned on. When the processor 14 monitors that the feedback frequency response difference deviates from the target frequency response difference, the low-frequency gain of the feedback microphone 13 is adjusted until the feedback frequency response difference is equal to the target frequency response difference, thereby completing the calibration process for feedback noise reduction.

In one embodiment, the memory 11 may be further configured to store a range of amplitude difference, and the calibration process for feedback noise reduction may further comprise the following steps: when it is determined that a difference between the feedback frequency response difference and the target frequency response difference exceeds the range of amplitude difference, the low-frequency gain of the feedback microphone 13 is not adjusted.

Specifically, if the noise reduction earphone 1 is not worn by the user, the user does not wear the noise reduction earphone 1 properly, or the noise reduction earphone 1 is used abnormally, the processor 14 performs the calibration process for feedback noise reduction, which causes the low-frequency gain of the feedback microphone 13 to be incorrectly adjusted. Therefore, to avoid the above situation, the processor 14 may further determine whether the difference between the feedback frequency response difference and the target frequency response difference exceeds the range of amplitude difference. If the processor 14 determines that the difference between the feedback frequency response difference and the target frequency response difference exceeds the range of amplitude difference, it means that the noise reduction earphone 1 is not worn by the user, the user does not wear the noise reduction earphone 1 properly, or the use of the noise reduction earphone 1 is abnormal. At this time, the processor 14 does not adjust the low-frequency gain of the feedback microphone 13. In one example, the range of amplitude difference may be, but is not limited to, the range of plus and minus 2 dB of the target frequency response difference.

In the calibration process for feedback noise reduction of this embodiment, the processor 14 first determines whether the feedback frequency response difference is less than or greater than the target frequency response difference; when the processor 14 determines that the feedback frequency response difference is equal to the target frequency response difference, it means that the calibration process for feedback noise reduction is completed; when the processor 14 determines that the feedback frequency response difference is less than or greater than the target frequency response difference, it is necessary to further determine whether the difference between the feedback frequency response difference and the target frequency response difference exceeds the range of amplitude difference. When the processor 14 determines that the difference between the feedback frequency response difference and the target frequency response difference does not exceed the range of amplitude difference, the low-frequency gain of the feedback microphone 13 is adjusted and the feedback noise reduction detection is performed again. When the processor 14 determines that the difference between the feedback frequency response difference and the target frequency response difference exceeds the range of amplitude difference, the low-frequency gain of the feedback microphone 13 is not adjusted.

In one embodiment, when the noise reduction earphone 1 is powered on or the noise reduction earphone 1 is connected to an external electronic device and obtains power, the processor 14 receives the start signal. The external electronic device is an electronic device that can be plugged into the noise reduction earphone 1, and the external electronic device can be, but is not limited to, a smart phone, a tablet, a notebook, or a desktop computer. Specifically, when the noise reduction earphone 1 is a wireless earphone, the processor 14 receives the start signal while the noise reduction earphone 1 is powered on; when the noise reduction earphone 1 is a wired earphone, the processor 14 receives the start signal while the noise reduction earphone 1 is connected to the external electronic device and obtains the power; in other words, the noise reduction earphone 1 receives the start signal while obtaining the power.

In one embodiment, the sound signal is a prompt audio signal when the noise reduction earphone 1 is powered on or the noise reduction earphone 1 is connected to an external electronic device and obtains the power, and the prompt audio signal comprises a low frequency signal. By using the prompt audio signal when the noise reduction earphone 1 is powered on or the noise reduction earphone 1 is connected to the external electronic device and obtains the power as the sound signal, the user does not feel the execution of the calibration process for feedback noise reduction, and the user does not need to wait for the execution of the calibration process for feedback noise reduction. It should be noted that the time for the speaker 12 to play the prompt audio signal is sufficient to support the processor 14 to perform multiple feedback noise reduction detections and adjust the low-frequency gain of feedback microphone 13 to complete the calibration process for feedback noise reduction.

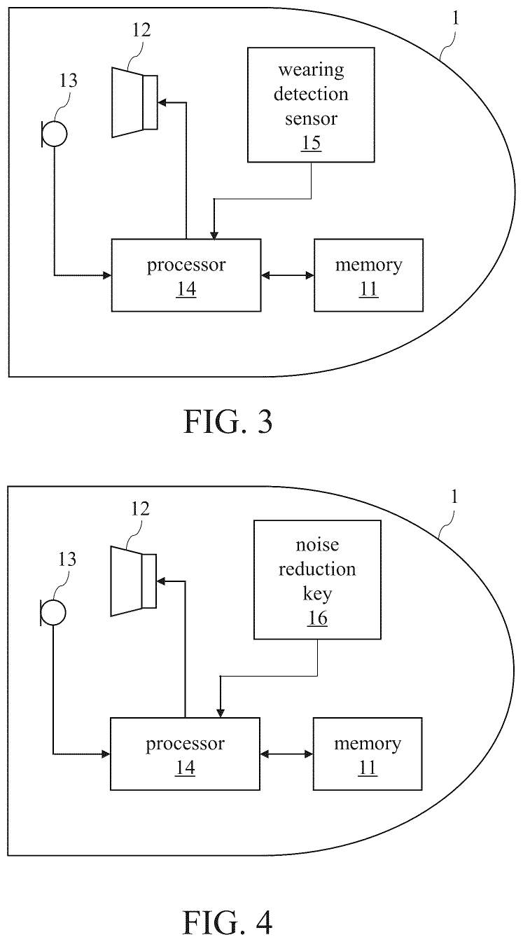

Please refer to FIG. 3, which is a block diagram of a noise reduction earphone according to another embodiment of the present disclosure. As shown in FIG. 3, the noise reduction earphone 1 may further comprise a wearing detection sensor 15, and the wearing detection sensor 15 is connected to the processor 14, and is configured to output the start signal to the processor 14 when it detects that the noise reduction earphone 1 is worn by the user. In other words, when the user wears the noise reduction earphone 1, the processor 14 receives the start signal, which can avoid the situation where the low-frequency gain of the feedback microphone 13 is incorrectly adjusted when the noise reduction earphone 1 is not worn by the user but the processor 14 performs the calibration process for feedback noise reduction. The wearing detection sensor 15 is configured to detect whether the noise reduction earphone 1 is worn by the user. The wearing detection sensor 15 may be, but is not limited to, a capacitive sensor, a pressure sensor, an optical sensor or a temperature sensor, to detect whether the noise reduction earphone 1 is worn by the user through the change of the sensed amount. The specific structure and working principle of the wearing detection sensor 15 are well known to a person having ordinary skill in the art, and no detailed description is given here.

Please refer to FIG. 4, which is a block diagram of a noise reduction earphone according to still another embodiment of the present disclosure. As shown in FIG. 4, the noise reduction earphone 1 may further comprise a noise reduction key 16, which is connected to the processor 14 and is configured to output the start signal to the processor 14 when pressed. In other words, when the user wears the noise reduction earphone 1 and presses the noise reduction key 16, the processor 14 receives the start signal, that is, the user can start the processor 14 to perform the calibration process for feedback noise reduction according to demand.

In one embodiment, the sound signal is a preset audio signal, and the preset audio signal includes a low-frequency signal. The preset audio signal is a test audio signal preset before the noise reduction earphone 1 leaves the factory. It should be noted that the time for the speaker 12 to play the preset audio signal is sufficient to support the processor 14 to perform multiple feedback noise reduction detections and adjust the low-frequency gain of feedback microphone 13 to complete the calibration process for feedback noise reduction.

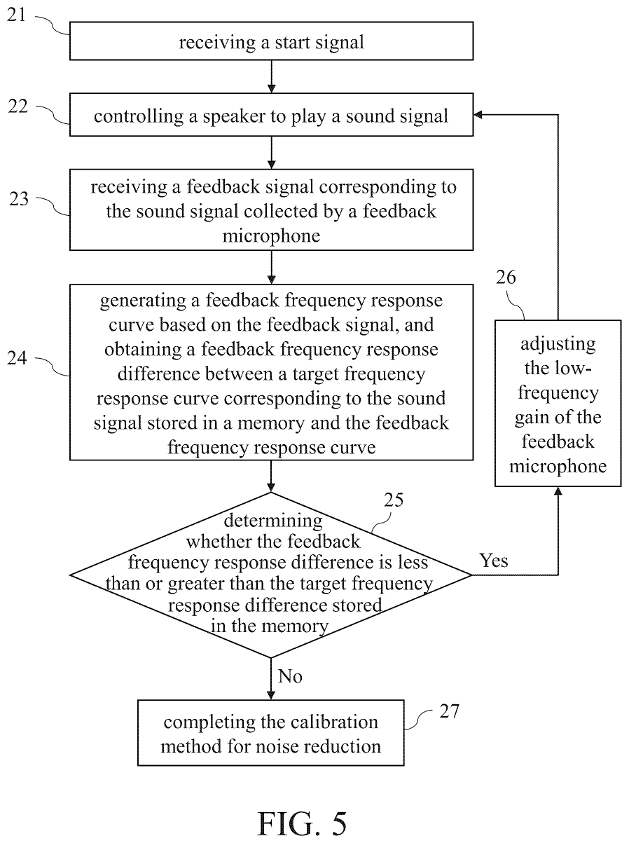

Please refer to FIG. 5, which is a flow chart of a calibration method for noise reduction according to an embodiment of the present disclosure. As shown in FIG. 5, the calibration method for noise reduction may be applied to the noise reduction earphone 1 of FIG. 1, FIG. 3 and FIG. 4, and the calibration method for noise reduction comprises the following steps: receiving a start signal (step 21); controlling a speaker 12 to play a sound signal (step 22); receiving a feedback signal corresponding to the sound signal collected by a feedback microphone 13 (step 23); generating a feedback frequency response curve based on the feedback signal, and obtaining a feedback frequency response difference between a target frequency response curve corresponding to the sound signal stored in a memory 11 and the feedback frequency response curve (step 24); determining whether the feedback frequency response difference is less than or greater than the target frequency response difference stored in the memory 11 (step 25); if so, adjusting the low-frequency gain of the feedback microphone 13 (step 26), and returning to step 22; if not, determining that the feedback frequency response difference is equal to the target frequency response difference, indicating that the calibration method for noise reduction is completed (step 27).

Through the above steps, the processor 14 is configured to monitor the feedback frequency response difference obtained when the noise reduction earphone 1 plays the sound signal with the feedback noise reduction function turned on. When the processor 14 monitors that the feedback frequency response difference deviates from the target frequency response difference, the low-frequency gain of the feedback microphone 13 is adjusted until the feedback frequency response difference is equal to the target frequency response difference, so as to complete the calibration process for feedback noise reduction, thereby improving the feedback noise reduction performance of the noise reduction earphone 1 in different wearing environments. Among them, the sound signal comprises a low frequency signal, and the different feedback of different users after wearing the noise reduction earphone can be reflected in the different feedback frequency response curves corresponding to the sound signal. The detailed description has been given in the above paragraphs and will not be repeated here.

In one embodiment, in addition to the above step 21 to step 27, the calibration method for noise reduction may further comprise the following steps: when it is determined that a difference between the feedback frequency response difference and the target frequency response difference exceeds a range of amplitude difference stored in the memory 11, not adjusting the low-frequency gain of the feedback microphone 13. The detailed description has been given in the above paragraphs and will not be repeated here.

In one embodiment, please refer to FIG. 3 and FIG. 5, step 21 may comprise receiving the start signal output by a wearing detection sensor 15 when detecting that the noise reduction earphone 1 is worn by a user. The detailed description has been given in the above paragraphs and will not be repeated here.

In one embodiment, please refer to FIG. 4 and FIG. 5, step 21 may comprise receiving the start signal output when a noise reduction key 16 is pressed. The detailed description has been given in the above paragraphs and will not be repeated here.

In one embodiment, step 21 may comprise receiving the start signal when the noise reduction earphone 1 is powered on or the noise reduction earphone 1 is connected to an external electronic device and obtains power. The detailed description has been given in the above paragraphs and will not be repeated here.

In summary, in the noise reduction earphone and the calibration method for noise reduction of the embodiments of the present disclosure, when the feedback frequency response difference between the target frequency response curve and the feedback frequency response curve corresponding to the same sound signal is less than or greater than the target frequency response difference, the low-frequency gain of the feedback microphone is adjusted until it is determined that the feedback frequency response difference is equal to the target frequency response difference, so as to improve the feedback noise reduction performance of the noise reduction earphone in different wearing environments, wherein the different feedback of different users after wearing the noise reduction earphone can be reflected in the different feedback frequency response curves corresponding to the sound signal. In addition, by setting the range of amplitude difference, it can avoid the situation where the processor performs the calibration process for feedback noise reduction or the calibration method for noise reduction when the noise reduction earphone is not worn by the user, the user does not wear the noise reduction earphone properly, or the noise reduction earphone is used abnormally, thereby causing the low-frequency gain of the feedback microphone to be incorrectly adjusted. Besides, when the noise reduction earphone is powered on, the noise reduction earphone is connected to an external electronic device and obtains power, the wearing detection sensor detects that the noise reduction earphone is worn by the user, or the noise reduction key is pressed by the user, the processor receives the start signal and performs the subsequent calibration process for feedback noise reduction and the calibration method for noise reduction.

While the present disclosure is disclosed in the foregoing embodiments, it should be noted that these descriptions are not intended to limit the present disclosure. On the contrary, the present disclosure covers modifications and equivalent arrangements obvious to those skilled in the art. Therefore, the scope of the claims must be interpreted in the broadest manner to comprise all obvious modifications and equivalent arrangements.

What is claimed is:

1. A noise reduction earphone, comprising:
a memory configured to store a target frequency response curve and a target frequency response difference corresponding to a sound signal, wherein the sound signal comprises a low frequency signal;
a speaker;
a feedback microphone configured to collect a feedback signal corresponding to the sound signal; and
a processor connected to the memory, the speaker and the feedback microphone, and configured to perform a calibration process for feedback noise reduction after receiving a start signal, wherein the calibration process for feedback noise reduction comprises the following steps: (a) controlling the speaker to play the sound signal; (b) receiving the feedback signal; (c) generating a feedback frequency response curve based on the feedback signal, and obtaining a feedback frequency response difference between the target frequency response curve and the feedback frequency response curve; (d) adjusting a low-frequency gain of the feedback microphone when it is determined that the feedback frequency response difference is less than or greater than the target frequency response difference, and returning to step (a) until it is determined that the feedback frequency response difference is equal to the target frequency response difference.

2. The noise reduction earphone according to claim 1, wherein the memory is further configured to store a range of amplitude difference, and the calibration process for feedback noise reduction further comprises the following steps: when it is determined that a difference between the feedback frequency response difference and the target frequency response difference exceeds the range of amplitude difference, not adjusting the low-frequency gain of the feedback microphone.

3. The noise reduction earphone according to claim 1, wherein when the noise reduction earphone is powered on or the noise reduction earphone is connected to an external electronic device and obtains power, the processor receives the start signal.

4. The noise reduction earphone according to claim 3, wherein the sound signal is a prompt audio signal when the noise reduction earphone is powered on or the noise reduction earphone is connected to the external electronic device and obtains the power, and the prompt audio signal comprises the low frequency signal.

5. The noise reduction earphone according to claim 1, further comprising a wearing detection sensor connected to the processor and configured to output the start signal to the processor when detecting that the noise reduction earphone is worn by a user.

6. The noise reduction earphone according to claim 5, wherein the sound signal is a preset audio signal, and the preset audio signal comprises the low frequency signal.

7. The noise reduction earphone according to claim 1, further comprising a noise reduction key connected to the processor and configured to output the start signal to the processor when pressed.

8. The noise reduction earphone according to claim 7, wherein the sound signal is a preset audio signal, and the preset audio signal comprises the low frequency signal.

9. A calibration method for noise reduction, which is applied to a noise reduction earphone comprising a memory, a speaker and a feedback microphone, and the calibration method for noise reduction comprising the following steps:
(A) receiving a start signal;
(B) controlling the speaker to play a sound signal, the sound signal includes a low-frequency signal;
(C) receiving a feedback signal corresponding to the sound signal collected by the feedback microphone;
(D) generating a feedback frequency response curve based on the feedback signal, and obtaining a feedback frequency response difference between a target frequency response curve corresponding to the sound signal stored in the memory and the feedback frequency response curve; and
(E) adjusting a low-frequency gain of the feedback microphone when it is determined that the feedback frequency response difference is less than or greater than a target frequency response difference stored in the memory, and returning to step (B) until it is determined that the feedback frequency response difference is equal to the target frequency response difference.

10. The calibration method for noise reduction according to claim 9, wherein the noise reduction earphone further comprises a wearing detection sensor, and the step (A) comprises: receiving the start signal output by the wearing detection sensor when detecting that the noise reduction earphone is worn by a user.

11. The calibration method for noise reduction according to claim 9, wherein the noise reduction earphone further comprises a noise reduction key, and the step (A) comprises: receiving the start signal output when the noise reduction key is pressed.

12. The calibration method for noise reduction according to claim 9, further comprising: when it is determined that a difference between the feedback frequency response difference and the target frequency response difference exceeds a range of amplitude difference stored in the memory, not adjusting the low-frequency gain of the feedback microphone.

13. The calibration method for noise reduction according to claim 9, wherein the step (A) comprises: receiving the start signal when the noise reduction earphone is powered on or the noise reduction earphone is connected to an external electronic device and obtains power.
